(19) United States
(12) Patent Application Publication
(10) Pub. No.: US 2025/0187846 A1
(43) Pub. Date: Jun. 12, 2025

(54) CLEANING DEVICE FOR CLEANING A SYSTEM COMPONENT, CLEANING SYSTEM, ARRANGEMENT AND CONVEYOR SYSTEM

(71) Applicant: Coperion GmbH, Stuttgart (DE)

(72) Inventors: Matthias SCHORER, Amtzell (DE); Max LANGENBERGER, Kleintissen (DE); Cornel FUEST, Ravensburg (DE); Bruno ZINSER, Waldburg (DE); Jochen SPRUNG, Ravensburg (DE); Robin WEILER, Ravensburg (DE)

(73) Assignee: Coperion GmbH, Stuttgart (DE)

(21) Appl. No.: 18/969,581

(22) Filed: Dec. 5, 2024

(30) Foreign Application Priority Data
Dec. 7, 2023 (DE) 10 2023 134 325.4

(51) Int. Cl. B65G 45/26; A47L 9/00; A47L 9/28

(52) U.S. Cl. CPC B65G 45/26; A47L 9/0063; A47L 9/009; A47L 9/2805; A47L 9/2894; A47L 2201/024

(57) ABSTRACT

Cleaning apparatus for cleaning an installation component of a conveyor system for conveying bulk material, comprising: at least one cleaning tool for cleaning at least a part of the installation component, and a carrier section for fastening the cleaning apparatus to the installation component, to a transport device, and/or to an external object, wherein the cleaning apparatus is designed to independently initiate a cleaning process for cleaning at least a part of the installation component, and a cleaning system including such a cleaning apparatus, and a service station, an assembly comprising the cleaning apparatus, and the installation component and a conveyor system.

### CROSS-REFERENCE TO RELATED APPLICATIONS

This application claims priority to Gereman Application No. 10 2023 134 325.4, filed on Dec. 7, 2023, which is incorporated herein by reference in its entirety.

### TECHNICAL FIELD

The disclosure relates to a cleaning apparatus for cleaning an installation component, for example a cellular wheel sluice. The disclosure further relates to a cleaning system, an assembly and a conveyor system which includes a cleaning apparatus of such kind.

### BACKGROUND

Cleaning installation components of bulk material conveyor systems poses significant practical challenges with regard to cleaning performance, reproducibility and effort. Manual cleaning of the installation components is particularly unsatisfactory. A high risk of injury to personnel who must clean the installation components manually is also a factor that cannot be ignored. Safe, efficient cleaning is critically important, especially when processing harmful substances for the manufacture of batteries or pharmaceuticals, for example, but also when strict hygiene requirements or degrees of purity are at issue in processing foodstuffs (e.g., in order to avoid certain allergens).

The problem to be addressed by embodiments is that of improving a cleaning apparatus of the kind described in the introduction in terms of structure and/or function. A further problem to be addressed by embodiments is that of improving a cleaning system, an assembly and a conveyor system in terms of structure and/or function.

### SUMMARY

The object underlying embodiments is therefore to provide a cleaning apparatus that, besides delivering comprehensive cleaning performance, also enables safe, efficient cleaning of installation components.

This object is solved with a cleaning apparatus having the features of claim 1. Otherwise, the object is also solved with a cleaning system having the features of claim 13. The object is further solved with an assembly having the features of claim 14 and with a conveyor system having the features of claim 17. Advantageous variants and/or further developments are the subject matter of the subordinate claims, the description, and/or the accompanying figures.

Both the features described in the patent claims and those in the following exemplary embodiments of the apparatus according to embodiments are each designed to refine the object, either individually or in combination with each other. The respective feature combinations do not represent a limitation with regard to the further developments of the object but are essentially only exemplary in nature.

The essence of embodiments consists in particular in that the cleaning apparatus is able to initiate a cleaning process for cleaning the installation component independently, and particular can carry out the cleaning automatically.

According to one aspect, a cleaning apparatus designed for cleaning an installation component of a conveyor system is provided. The cleaning apparatus may also be described as a cleaning satellite and/or designed as a cleaning robot. In this context, the conveyor system is designed to convey bulk material. In one variant, the conveyor system may be configured as a pneumatic conveyor system. The bulk material may be granules, granular material, particles, powder or flakes. For example, the bulk material may be a synthetic material, a foodstuff such as milk powder or milk substitute powder, animal feed, a pharmaceutical or medicinal substance, a medication or battery material such as a coating mixture or an anode or cathode material.

In order to clean at least a part of the installation component, the cleaning apparatus includes at least one cleaning tool. In particular, the cleaning apparatus and/or its cleaning tool may be configured for dry, damp and/or wet cleaning. The at least one cleaning tool may be for example a blower, spraying element, brush unit, blade unit and/or wiper device. A suction device may also serve as a cleaning tool. Alternatively, the cleaning tool may additionally be equipped with a suction device. The cleaning tool may include for example at least one spray head, at least one spray nozzle, at least one air nozzle, at least one brush, at least one blade/scraper and/or at least one wiper. In one variant, these cleaning elements may also be designed to rotate or turn. The blower may comprise the at least one air nozzle. The blower may be designed to blow out dry or damp air for example. In one variant, the blower may be designed to deliver and/or blow out temperature controlled, for example cold, warm or hot air. Further, the blower may be connected to a source of air, for example a source of compressed air. Thus, the blower may also blow compressed air. The cleaning tool may include for example at least one wet wiper or at least one wet brush. In one variant, the cleaning tool may include at least one spray ball, spray lance, directed jet cleaner or orbital cleaner. The cleaning tool may thus be designed to spray the inside of the installation component or a part thereof, with a cleaning agent, for example. In a further variant, the cleaning tool may comprise a laser device, ultrasonic device or a blasting device, for example a sand blaster or glass bead blaster. The at least one cleaning tool is thus able to clean the installation component or at least a part of the installation component and consequently remove dirt and/or deposits from it.

The cleaning apparatus further includes a carrier section, which is designed for fastening the cleaning apparatus to the installation component, a transport device and/or an external object. In one variant, the cleaning apparatus may therefore be embodied as a stationary cleaning apparatus, attached to the installation component or the external object, for example. The external object may be for example a part or a section of the conveyor system or a part of the building in which the conveyor system is installed, such as a wall, ceiling or the floor of a building. The connection between the cleaning apparatus and the installation component or the external object may have the form of a flange connection, screw connection and/or clamping connection, and/or the carrier section may include such a connection. The carrier section may further include a hinge, an arm, such as a robot arm or telescopic arm, a cylinder, and/or a guide such as a linear guide. In one variant, the carrier section may comprise a docking element for docking with the installation component, the transport device and/or the external object. In a further variant, the cleaning apparatus may be designed as a mobile cleaning apparatus, by means of the transport device, for example, by which the cleaning apparatus is able to move independently or is mobile in the application area. In this case, the cleaning apparatus may be connected to the transport device via the carrier section.

The cleaning apparatus is in particular designed to initiate and/or perform a cleaning process for cleaning at least a part of the installation component independently. Accordingly, the cleaning apparatus is capable of performing the cleaning of the installation component independently, in particular by means of the at least one cleaning tool. The term independently may also be understood to mean that the cleaning apparatus is able to initiate a cleaning process automatically, and/or to carry out cleaning of the installation component or at least a part thereof automatically. The cleaning apparatus may also be configured to receive an external command to start a cleaning process and/or to start a cleaning process automatically after a defined time interval has elapsed, for example, and/or on the basis of an evaluation as to whether cleaning is necessary or not. The cleaning apparatus may thus be designed for autarchic cleaning.

Consequently, the manual effort associated with cleaning the installation component is reduced or entirely eliminated. Independent and/or automatic cleaning of the installation component is made possible with the cleaning apparatus. In particular, the cleaning apparatus enables automated, for example autonomous or semi-autonomous cleaning of the installation component. Consequently, the cleaning apparatus creates the conditions required for semi-or fully automated cleaning of the installation component. In particular, this makes it possible to meet hygiene requirements and perform safe, efficient cleaning more effectively, in particular without human interaction. Health risks when cleaning the installation component due to harmful, in particular toxic substances, for example from the use of toxic or irritating cleaning agent or in the domain of pharmaceutical product manufacture and/or battery manufacture, are also reduced or avoided entirely.

In one variant, the cleaning apparatus may include a communication interface. The communication interface may be configured to communicate with the installation component and/or with a controller of the conveyor system. In particular, the communication interface may be designed to receive and/or transmit signals and/or data. For example, the communication interface may be configured to receive a cleaning signal. In order to process the signals and/or data, the cleaning apparatus may have a controller a processor and/or a memory, for example. In one variant, the cleaning apparatus may be designed to initiate and/or carry out the cleaning process after a cleaning signal has been received via the communication interface.

In embodiments, the installation component is or comprises a conveyor installation, a feed element, a supply device, a dosing apparatus, a sluice, a rotating part, a diverter, a gate valve, a butterfly valve or a screw conveyor. The sluice may be a cellular wheel sluice, blasting sluice or discharge sluice, for example. The gate valve may be embodied as a shutoff gate. In one variant, the installation component may be designed to feed or discharge bulk material into or from a conveyor line of the conveyor system. In another variant, the installation component may be or comprise a mixing apparatus or a separator. The separator may be an apparatus for grading solid substances according to defined criteria, a sifter for example.

In a variant, the installation component may be embodied as a cellular wheel sluice. The cellular wheel sluice may include a housing with an interior chamber and a cover that is fastened detachably to the extraction side of the housing. The cellular wheel sluice may further include a cellular wheel. The cellular wheel may be arranged in an operating position in the housing so as to be drivable in rotation about a longitudinal axis and retained on the extraction side cover. In one variant, the cellular wheel sluice has an extraction apparatus for shifting the cellular wheel between the operating position and an extraction position. The extraction apparatus may be a guide unit for the guided displacement of the cellular wheel along an extraction direction parallel to the longitudinal axis. The extraction apparatus may further comprise an extraction drive, particularly motorised, mounted fixedly on the housing and coupled to the extraction side cover, for the mechanically powered displacement of the extraction side cover with the cellular wheel. The cellular wheel may thus be driven and displaced in guided manner between an operating position and an extraction position by means of the extraction apparatus. In this way, a semi-or fully automated displacement of the cellular wheel into the extraction position may be carried out in preparation for a cleaning process.

The cleaning apparatus may include a recognition sensor system. The recognition sensor system may be configured in particular to recognise a state of the installation component, for example whether the installation component is in an open or closed state. In addition or alternatively thereto, the recognition sensor system may be configured to recognise whether the installation component is in an extended or a retracted state. At the same time, the cleaning apparatus may be designed to initiate and/or carry out a cleaning process on the basis of the recognised state. In one variant, the recognition sensor system may be configured to recognise an open or closed state of the cellular wheel sluice and/or an extended or retracted state of the cellular wheel sluice, that is to say a state in which the cellular wheel is in the operating position or the extraction position. In this context, the cleaning apparatus may be designed to initiate and/or carry out a cleaning process when it has been recognised that the cellular wheel sluice is in the open or extended state and the cellular wheel is in the extraction position.

In one variant, the cleaning apparatus may comprise a cleaning section, which together with the installation component or a part thereof is designed to delimit a cleaning space. In this situation, the cleaning section may be constructed to correspond to or complement the installation component or a part thereof. For example, the cleaning section may be constructed as a cover piece, such as a side cover. The cleaning section may thus be constructed as a side cover of a cellular wheel sluice. The cleaning section may be designed as a cleaning side cover, for example, which can be pressed or pushed onto the housing of the installation component. The at least one cleaning tool may be arranged on the cleaning section. And at least one drive for the cleaning tool and/or at least one drive for a functional element of the installation component may be provided on the cleaning section, for example on a side of the cleaning section facing away from the cleaning tool and the functional element. In addition or alternatively thereto, a drive module may be provided. The drive module may include at least one drive for the cleaning tool and/or at least one drive for the functional element of the installation component. The at least one drive may be designed to drive, for example rotate, the functional element of the installation component. Further, at least one line may be provided on the cleaning section for supplying an auxiliary material, such as energy, electrical current, air, water, blasting agent, cleaning agent or the like, and/or at least one line may be provided on a side of the cleaning section facing away from the cleaning tool for removing a contaminant. In one embodiment, the cleaning section may be designed to be movable by means of a movement device, for example by at least one linear guide, a rotating device or an arm, such as an articulated, swivel, and/or guide arm. Thus, when the installation component is open the cleaning tool may be introduced into the interior of the installation component housing by the cleaning apparatus or its movement device. This means that the cleaning tool may be designed to allow it to be introduced into the installation component housing. At the same time, the cleaning section may close the installation component, in particular in such a way that the interior of the housing forms the cleaning space. The cleaning section may thus be constructed such that together with the installation component or a part thereof it delimits a closed cleaning space. In this way, the interior of the installation component housing can be cleaned easily by means of the cleaning apparatus and/or its cleaning tool.

Additionally or alternatively, the cleaning section may be designed to enclose the installation component or a part thereof in a cleaning space. In this context, the cleaning section may be embodied as a housing, for example as a cylinder housing or drum, e.g., a washing drum. The housing may also be referred to as a cleaning housing. In one variant, the housing may be designed to be open on one side, for example as a hollow cylinder open on one side. Additionally or alternatively, the housing may also be of multipart, e.g., two-part construction. In this case, the housing may be formed by two half-shells, which may be designed to be movable relative to each other. The housing may also delimit and define an interior, such as a cleaning space. The cleaning section may thus form an enclosure for at least a part of the installation components, e.g., for the cellular wheel. The at least one cleaning tool may be arranged inside the housing or in the interior thereof. Further, at least one drive for the cleaning tool and/or at least one drive for a functional element of the installation component may be provided on the housing. Additionally or alternatively thereto, a drive module may be provided. The drive module may include at least one drive for the cleaning tool and/or at least one drive for the functional element of the installation component. The at least drive may be designed to drive, for example rotate, the functional element of the installation component. Further, at least line for supplying an auxiliary material such as energy, electrical current, air, water, blasting agent, cleaning agent or the like, and/or at least one line for removing a contaminant may be provided on the housing. In one embodiment, the cleaning section may be designed to be movable by means of a movement device, for example by at least one linear guide, a rotating device or an arm, such as an articulated, swivel, and/or guide arm. Thus, when the installation component is open, the cleaning section and/or housing may surround a part of the installation component, such as the cellular wheel, or fit over it. Then, the cleaning section may enclose the installation component or a part thereof, for example in such manner that the interior of the cleaning section together with the part of the installation component forms the cleaning space. The cleaning section may thus be constructed to delimit a closed cleaning space together with the installation component or a part thereof. In this way, at least a part of the installation component, such as a cellular wheel for example, can be cleaned easily by means of the cleaning apparatus and its cleaning tool.

The cleaning section may comprise a connection section for connecting and/or docking it to the installation component or to a part thereof. The connection section be embodied as a flange part, for example. In one variant, the connection section may be arranged on the cover piece of the cleaning section, or it may be formed thereby. In another variant, the connection section may be arranged on the housing of the cleaning section, or it may be formed thereby, for example at or by the open side of the housing. Further, the connection section may include a sealing element which is designed to connect the cleaning section to the installation component or a part thereof to each other in sealing manner.

The cleaning apparatus may include at least one extraction device for extracting dirt by suction. The extraction device may be configured for dry and/or wet suction, for example. In one variant, the extraction device may have at least one suction line, which is arranged on the cleaning section for example and/or protrudes or opens into the cleaning space. In addition, a suction pump may be provided, which in particular is operatively connected to the at least one suction line.

The cleaning apparatus may have at least one storage reservoir to collect an auxiliary material or contaminant. In one variant, the cleaning apparatus may have one storage reservoir for contaminants and at least one storage reservoir for an auxiliary material. An auxiliary material may be for example energy, e.g., electrical energy or electrical current, air, e.g., scavenging air, compressed air, hot air or cool air, water, e.g., fresh water, flushing water, hot water or cool water, a blasting agent, e.g., sand or glass, or a cleaning agent, e.g., solvent, rinsing agent or foam concentrate. A contaminant may be for example dirt in dry, wet or fluid form, e.g., particles, powder, dust or wastewater. The at least one storage reservoir may therefore be a tank for holding an auxiliary material or a storage device such as an energy storage system such as a rechargeable battery or battery. Additionally or alternatively, the cleaning apparatus may include at least one transfer interface for transferring an auxiliary material or contaminant. For this purpose, the transfer interface have at least one transfer line. The at least one transfer interface or the at least one transfer line thereof may be designed to be connectable to a service station. The service station may be a separately provided service station or a service station arranged on and/or assigned to the installation component. In this case, the contaminant and/or the at least one auxiliary material may be transferred from the cleaning apparatus to a service station. In this way, the storage reservoirs can be emptied, but also, if such is intended, filled and/or charged. In addition or alternatively, the transfer interface may also be connectable or connected to an interface provided on the installation component or conveyor system for removing contaminants and/or supplying auxiliary materials.

In one variant, the carrier section may include a movement device. The movement device may have at least one linear guide, for example two or three linear guides. In such case, the linear guides may be arranged substantially perpendicularly to each other, for example so that a linear guidance can take place along two or three mutually perpendicular axes. Additionally or alternatively, the movement device may include a swivel mechanism, e.g., a rotating device, with which a swiveling or rotary motion can be performed about an axis, for example a vertical axis, normal axis or transverse axis. In one embodiment, an arm, such as an articulated, swivel and/or guide arm may be provided. The arm may also be embodied as a robot arm, for example, with one, two, three or multiple axes. Alternatively, the carrier section may be constructed in the manner of a hinge or it may at least include a hinge element. The cleaning apparatus may be moved relative to the installation component by the movement device. In particular, the cleaning section may be connected to the movement device, so that a movement of the cleaning section relative to the installation component can be performed.

In a variant, the cleaning apparatus may comprise the transport device. In such case, the cleaning apparatus may be fastened to or mounted on the transport device by means of the carrier section. In particular, the transport device may be designed to transport the cleaning apparatus. In one variant, the transport device may be embodied as an autonomously or semi-autonomously self-propelled vehicle or self-flying aerial vehicle. In such case, this may be for example a motor-powered vehicle or flight-capable drone. The vehicle or aerial vehicle may comprise at least one storage reservoir for holding an auxiliary material and/or contaminant. In one variant, the vehicle or aerial vehicle may comprise at least one storage device, for example an energy storage system such as a rechargeable battery or a battery. The vehicle or aerial vehicle may further comprise the at least one cleaning tool, for example the spraying element. Accordingly, the cleaning apparatus may also be designed as a cleaning vehicle or cleaning drone. For this purpose, the transport device may comprise at least one drive, for example a motor, such as an electric motor and/or rotor. The transport device may further be equipped with wings, rotationally drivable wheels and/or rotor blades. In one variant, the transport device may be configured for autonomous or semi-autonomous propulsion. Additionally or alternatively, the transport device may be configured to allow remote control operation and/or for manual operation. Autonomous or semi-autonomous propulsion, or alternatively remote control operation is particularly advantages when harmful substances, such as substances used in the manufacture of pharmaceutical products or batteries are to be processed and/or moved via the conveyor system.

The transport device may also comprise a controller that is configured to control the transport device. For this purpose, an environment sensor system may be provided, which is configured to provide the controller with the environmental data reproducing an environment of the cleaning apparatus. In addition or alternatively, a navigation system may be provided which is configured to determine the current position of the cleaning apparatus. The controller may be connected to a central controller and/or to the controller of the conveyor system in particular wirelessly, that is to say by radio. The controller may be configured to receive and/or transmit data, information or signals.

Consequently, the cleaning apparatus may be capable of moving independently and/or autonomously by means of the transport device, in particular in an application space or application area. Thus it is possible for the cleaning apparatus to clean multiple installation components of the conveyor system, including sites that are difficult to access. The cleaning apparatus may be designed so that, at least in the application space or application area, independent orientation may be assured for example by processing a position that is detected by the environment sensor system and/or made available by a navigation system. For this purpose, the navigation system is able to incorporate stored map data, for example for determining and/or comparing a position, and/or to access said data via an interface. The navigation system may be or include a GPS navigation system for example. The application space or application area may be the area or space defined and/or delimited by the conveyor system, or alternatively just a subregion thereof.

According to a further aspect, a cleaning system is provided for cleaning an installation component of a conveyor system. A conveyor system is used to convey bulk material. The installation component and/or conveyor system may be designed as described previously and/or as follows. The cleaning system comprises in particular at least one cleaning apparatus, which may be designed as described previously and/or as follows. The cleaning system may further include at least one service station. The cleaning apparatus is configured in such manner that it can move independently and/or automatically, for example by means of the transport device, to the service station. The cleaning apparatus is able to detect whether or not it is necessary to travel to a service station, for example. Travelling to the service station may be necessary for example if a storage reservoir, e.g., an auxiliary material tank and/or waste tank of the cleaning apparatus is substantially empty or full. This may also include the need to charge a battery of the cleaning apparatus.

At the service station, the cleaning apparatus is able to draw the least one auxiliary material and/or energy for charging a battery from the service station. The cleaning apparatus is also able to transfer the at least one contaminant to the service station. At the same time, the service station may be configured to transfer at least one auxiliary material and/or contaminant to or from the at least one cleaning apparatus. For this purpose, the service station may be equipped with at least one service port for connecting to the at least one cleaning apparatus. In order to connect with the at least one service port, the cleaning apparatus may then comprise at least one connection port. The transfer of an auxiliary material or removal of contaminant can then proceed according to requirement. In order to hold at least one auxiliary material and/or contaminant, the service station may include at least one tank. The service station may also have at least one charging device which is configured to charge a battery and/or rechargeable battery of the at least one cleaning apparatus.

After picking up the one or more auxiliary materials, via the ports, for example, after a charging cycle and/or after discharging contaminant, the cleaning apparatus is able to return to the site of the cleaning task, travel to a new cleaning task, or remain on standby in a readiness mode for a future cleaning task.

According to a further aspect, an assembly is provided that comprises at least one cleaning apparatus and at least one installation component. The at least one cleaning apparatus may be designed as described previously and/or as follows. In one variant, the cleaning apparatus may be attached to the installation component via the carrier section. In an alternative variant, the cleaning apparatus may be attached to the external object.

The at least installation component may be designed as described previously and/or as follows. For example, the installation component may be or include a conveyor installation, a feed element, a supply device, a dosing apparatus, a sluice, a rotating part, a diverter, a gate valve, a butterfly valve or a screw conveyor. The sluice may be for example a cellular wheel sluice, blasting sluice or discharge sluice. The cellular wheel sluice may be designed as described previously and/or as follows. The gate valve may be embodied as a shutoff gate. In one variant, the installation component may be designed to feed or discharge bulk material into or out of a conveyor line of the conveyor system. In another variant, the installation component may be or comprise a mixing apparatus or a separator. The separator may be an apparatus for grading solids according to defined criteria, a sifter for example.

In a variant, the at least one installation component is designed to be opened manually or automatically. For this purpose, the installation component may include an extraction apparatus for shifting a functional element of the installation component between an operating position and an extraction position. This enables the functional element to be designed such that it is movable out of an installation component housing. The functional element may be for example a rotating part, a cellular wheel, a gate valve, a butterfly valve or a screw conveyor. The extraction apparatus may include a guidance unit for guided displacement of the functional element along an extraction direction parallel to the longitudinal axis. The extraction apparatus may further comprise an extraction drive, motorised for example, for the mechanically powered displacement of the functional element. The functional element may thus be driven and displaced in guided manner between an operating position and an extraction position by means of the extraction apparatus. In this way, a semi-or fully automated displacement of the functional element into the extraction position for a cleaning process may be carried out.

According to a further aspect, a conveyor system is provided for conveying bulk material. The conveyor system comprises at least one assembly, which is designed as described previously and/or as follows. In addition or alternatively, the conveyor system may include a cleaning system. The cleaning system may be designed as described previously and/or as follows.

### BRIEF DESCRIPTION OF THE DRAWINGS

In the following text, embodiments will be described in greater detail with reference to the figures, which show schematically and for exemplary purposes only:

FIG. 1 a cleaning system for cleaning an installation component of a conveyor system;

FIG. 2a variant of a cleaning apparatus;

FIG. 3a further variant of a cleaning apparatus; and

FIG. 4a variant of a cleaning tool.

### DETAILED DESCRIPTION

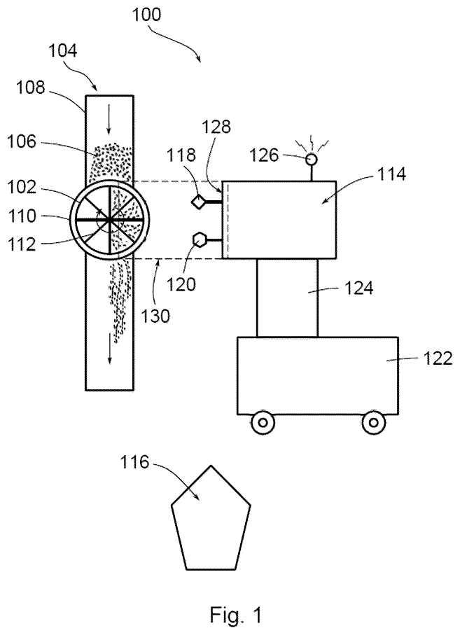

FIG. 1 is a schematic representation of a cleaning system 100 for cleaning an installation component 102 of a conveyor system 104. The conveyor system 104 is designed to convey bulk material 106 and comprises at least one conveyor line 108, in which the installation component 102 is integrated. In the present embodiment, the installation component 102 has the form of a cellular wheel sluice 102. The cellular wheel sluice 102 includes a housing 110 with an interior and a cellular wheel 112 mounted rotatably inside the housing 110. The cellular wheel sluice 102 also has am extraction side cover (not shown in FIG. 1) fastened detachably to the housing 110. The cellular wheel 112 is arranged in an operating position in the housing 110 so as to be drivable in rotation about a longitudinal axis and retained on the extraction side cover. The cellular wheel sluice 102 also has an extraction apparatus (not shown in FIG. 1) for shifting the cellular wheel 112 between the operating position and an extraction position. The extraction apparatus may include a guide unit for the guided displacement of the cellular wheel 112 along an extraction direction parallel to the longitudinal axis. The extraction apparatus may further comprise an extraction drive, particularly motorised, mounted fixedly on the housing and coupled to the extraction side cover, in particular for the motorised extraction drive for mechanically driven displacement of the extraction side cover with the cellular wheel 112. The cellular wheel 112 may thus be displaced in guided manner between the operating position and the extraction position by means of the extraction apparatus. Since the cellular wheel sluice 102 is designed for automatic opening, a semi-or fully automated displacement of the cellular wheel 112 into the extraction position or cleaning position may be carried out in particular for a cleaning process.

The cleaning system 100 thus comprises at least one cleaning apparatus 114 for cleaning the cellular wheel sluice 102, and at least one service station 116 for transferring at least one auxiliary material and/or contaminant to or from the at least one cleaning apparatus 114. An auxiliary material may be example energy, electrical current, air, water, blasting agent, cleaning agent or the like. In the present embodiment, the cleaning apparatus 114 is designed to receive at least one auxiliary material from a tank or storage system of the service station 116. To this end, the cleaning apparatus 114 can be connected to the service station 116, e.g., via a transfer interface such as a line or a connector, in such a way that at least one storage reservoir or storage system of the cleaning apparatus 114 can be filled or charged with the respective auxiliary material. The storage reservoirs serve to hold the auxiliary materials in readiness. Similarly, contaminant stored in a tank of the cleaning apparatus 114 that was collected during a cleaning process and received by the cleaning apparatus 114, may be discharged to the service station 116 to empty the contaminant tank of the cleaning apparatus 114.

The cleaning apparatus 114 is represented schematically in FIG. 1 and comprises at least one cleaning tool 118 for cleaning at least a part of the cellular wheel sluice 102. The cleaning apparatus 114 is, in embodiments, designed to initiate and/or perform a cleaning process for cleaning the at least one part of the cellular wheel sluice 102 independently and/or automatically. The cleaning tool 118 may be configured for dry, damp and/or wet cleaning. For example, the cleaning tool may be a spraying element, blower, brush unit, blade unit and/or wiper device. In order to pick up the contaminant arising from the cleaning by means of the cleaning tool 118, the cleaning apparatus 114 has at least one extraction device 120 removing the contaminant by suction after or during the cleaning process.

In the embodiment shown in FIG. 1, the cleaning apparatus 114 includes a transport device 122 and a carrier section 124. The cleaning apparatus 114 is fastened to the transport device 122 via the carrier section 124. Additionally or alternatively, the carrier section 124 may be designed to fasten the cleaning apparatus 114 to the cellular wheel sluice 102 and/or to an external object, for example the conveyor system 104, the conveyor line 108 thereof, or to a wall, ceiling or floor of the building in which the conveyor system is installed. The carrier section 124, in embodiments, comprises a movement device that is designed to move the cleaning apparatus 114 relative to the cellular wheel sluice 102. This enables optimal positioning of the cleaning tool 118 relative to the cellular wheel sluice.

The transport device 122 is designed to transport the cleaning apparatus 114. In the present embodiment according to FIG. 1, the transport device 122 is configured as an autonomously or semi-autonomously self-propelled vehicle. For this purpose, the transport device 122 has a drive, an electric motor, for example, and at least three wheels. The transport device 122 thus enables autonomous or semi-autonomous travel operation of the cleaning apparatus 114. In addition or alternatively, a remote control operation and/or a manual operation mode may be provided. For navigation in autonomous or semi-autonomous travel operation, the transport device 122 comprises an environment sensor system. The environment sensor system may include for example multiple radar sensors, lidar sensors or the like. In particular, the environment sensor system is configured to provide a controller with the environmental data reproducing an environment of the cleaning apparatus 114. In addition, a navigation system may be provided which is configured to determine the current position of the cleaning apparatus 114 in the application space or application area, to enable navigation for example from the service station 116 to the cellular wheel sluice 102 that is to be cleaned.

The cleaning apparatus 114 further has a communication interface 126 that is configured to communicate with the cellular wheel sluice 102 and/or with a controller of the conveyor system 104, which is not shown in FIG. 1. The communication interface 126 comprises in particular a transmission unit, a receiving unit and an antenna. The controller of the cleaning apparatus 114 is connected electrically to the communication interface 126, so that data and signals can be received and/or transmitted via the communication interface 126. In one variant, the cleaning apparatus 114 may be designed to initiate the cleaning process after a cleaning signal has been received via the communication interface 126.

Additionally or alternatively, it is possible that the cleaning apparatus 114 has a recognition sensor system which is configured to recognise a state of the cellular wheel sluice 102, in particular whether the cellular wheel sluice 102 is in an open or closed state and/or in an extended or retracted state, that is to say whether it is in the operating position or the extraction position. To this end, the recognition sensor system may include for example an optical detection means such as a camera. A cleaning process is then only begun when it has been detected that the cellular wheel sluice 102 is in der extraction position, and accordingly that the cellular wheel 112 is exposed.

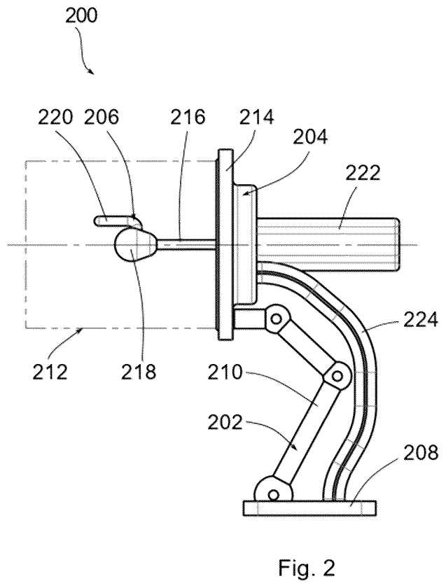

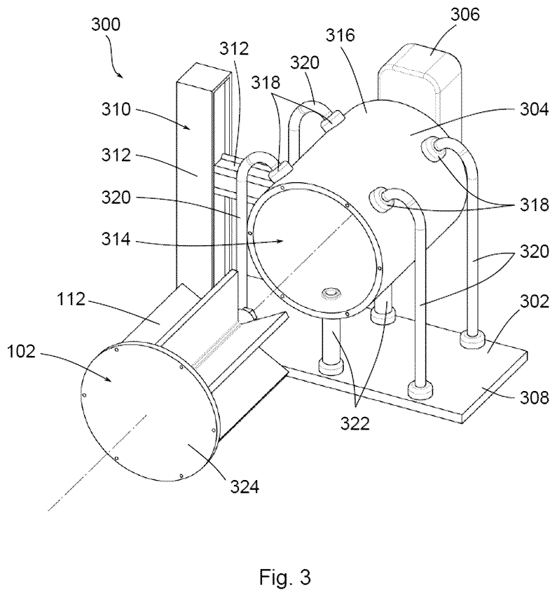

For optimal cleaning of the cellular wheel sluice 102 or at least a part thereof, the cleaning apparatus 114 comprises a cleaning section 128. The cleaning tool 118 is arranged on the cleaning section 128. As shown in the present embodiment, the extraction device may also be arranged on the cleaning section 128. In a variant that will be described below with reference to FIG. 2, the cleaning section 128 may delimit a cleaning space 130 together with the cellular wheel sluice 102 or a part thereof. In an alternative embodiment that will be described below with reference to FIG. 3, the cleaning section 128 may be designed to enclose the cellular wheel sluice 102 or a part thereof, for example the cellular wheel 112, in a cleaning space 130. In FIG. 1, the cleaning space 130 is represented purely schematically with dashed lines.

FIG. 2 shows a variant of a cleaning apparatus 200. The cleaning apparatus 200 comprises a carrier section 202, a cleaning section 204 attached thereto, and a cleaning tool 206 arranged on the cleaning section 204.

As shown in the embodiment represented in FIG. 2, the carrier section 202 includes a fastening part 208 for fastening to a transport device 122, the installation component 102, or to an external object. The fastening part 208 may be embodied as a flange part, for example. Moreover, the carrier section 202 includes a movement device 210 mounted on the fastening part 208, which in the present variant is embodied as an articulated arm 210, in this case a 3-axis articulated arm, and serves to move the cleaning section 204 attached to the articulated arm 210 relative to the installation component 102. The installation component 102 may be in particular a cellular wheel sluice 102.

As shown in FIG. 2, the cleaning section 204 together with the installation component 102 or a part thereof is designed to delimit a cleaning space 212. In such case, the cleaning section 204 is constructed to correspond to or complement the installation component 102 or a part thereof. In the case of a cellular wheel sluice 102, as represented in FIG. 2, the cleaning section 204 is embodied as a cover piece 214, such as a side cover. The cleaning section 204 is thus essentially constructed in the form of a side cover 214 of the cellular wheel sluice, which can be pressed or pushed onto the housing of the cellular wheel sluice 102 in order to close said housing when the cellular wheel 112 is extended and to clean the interior of the housing by means of the cleaning tool 206.

The cleaning tool 206 is arranged on one side of the cover piece 214, and in the present embodiment is configured as a spraying element 206. The spraying element 206 is mounted on a movable and/or rotatable lance 216, by which the spraying element 206 can be for moved and/or rotated about an axis in at least one axial direction. For the cleaning, the spraying element 206 has a spray head 218 and a spray nozzle 20, from which cleaning agent, water, air, etc. can be sprayed. A drive 222 is provided on the opposite side of the cover piece 214 and is operatively connected to the lance 216 to enable a linear and/or rotary motion of the lance 216. The spraying element 206 may thus be displaced further into the interior of the housing of the cellular wheel sluice 102. Additionally, a supply line 224 is arranged on the side of the cover piece 214 facing away from the spraying element 206 and serves to deliver the medium that is to be sprayed out of the spraying element 206. The supply line 224 is connected to the spraying element 206 for this purpose.

Thus, the spraying element 206 can be introduced into the interior of the cellular wheel sluice 102 housing by means of the articulated arm 210 when the cellular wheel sluice 102 is open. The housing of the cellular wheel sluice 102 is advantageously closed by the cover piece 214, in particular in such manner that the interior of the housing forms the cleaning space 212. In this way, the interior of the housing of the cellular wheel sluice 102 can be cleaned easily by the cleaning apparatus 200 and its spraying element 206.

Otherwise, reference is made for the sake of completeness in particular to FIG. 1 and the associated description.

FIG. 3 shows a further variant of a cleaning apparatus 300. The cleaning apparatus 300 comprises a carrier section 302, a cleaning section 304 fastened thereto, a cleaning tool (not shown in FIG. 3) arranged on the cleaning section 204, and a drive module 306.

According to the embodiment represented in FIG. 3, the carrier section 302 includes a fastening part 308 embodied as a fastening plate for fastening to a transport device 122, the installation component 102, or an external object. The carrier section 302 further includes a movement device 310 mounted on the fastening part 308, which device is embodied in the present variant as a linear guide device 310 and serves to move the cleaning section 304 attached to the linear guide device 310 relative to the installation component 102. As represented in FIG. 3, the installation component 102 may be a cellular wheel 112 of a cellular wheel sluice 102. The linear guide device 310 comprises two linear guides 312 arranged perpendicularly to one another, each with guide rods and drive. This enables the cleaning section 304 to be displaced both vertically and horizontally and relative to the cellular wheel 112.

In the present embodiment according to FIG. 3, the cleaning section 304 is designed to enclose the cellular wheel 112 of the cellular wheel sluice 102 in a cleaning space 314. In embodiments, the cleaning section 304 is embodied as a housing 316, in this case as a cylinder housing or drum, in such a way that an interior of the housing 316 defines and forms the cleaning space 314. As shown in FIG. 3, the housing 316 is open on one side, to allow the cellular wheel 112 to pass into the cleaning space. The cleaning section 304 is thus a kind of cleaning or washing drum and forms an enclosure for the cellular wheel 112 for cleaning purposes. On the opposite side of the opening in the housing, the cleaning tool protrudes into the cleaning space 314 and may be driven for example by means of a first drive of the drive module 306 to carry out a cleaning operation. In the present variant, several spray nozzles 318 are also arranged on the housing 316 and open into the cleaning space 314. An auxiliary material, e.g., cleaning agent, water or air, but also a flushing agent can be sprayed into the cleaning space 314 and consequently onto the cellular wheel 112 via the spray nozzles 318. Supply lines 320 connected to the spray nozzles 318 are provided to deliver the auxiliary material or flushing agent. Drain lines 322, in embodiments arranged close to the floor of the housing 316, and the ends of which open into the cleaning space 314, are also provided to drain off a contaminant.

When the cellular wheel sluice 102 is open, the housing 316 of the cleaning section 304 can now be moved by means of the linear guide device 310 and optionally by means of the transport device 122 in such manner that the cellular wheel 112 is advanced into the cleaning space 314 and enclosed. At the same time, the side cover 324 on which the cellular wheel 122 is supported reaches an end position abutting with the housing 316 of the cleaning section 304. In embodiments, the opening in the housing is not closed thereby. For this purpose, a flange part and/or sealing element may be provided on the housing 316 to this end. The cellular wheel 112 is now enclosed in the cleaning space 314, and the cleaning process for cleaning the cellular wheel 112 by means of the cleaning tools and the spray nozzles 318 can begin. In one variant, the cellular wheel 112 may be designed so that it can be coupled to a second drive of the drive module 306. This enables the cellular wheel 112 to be driven by the second drive of the drive module 306 and caused to rotate inside the cleaning space 314. This further improves the cleaning performance.

Otherwise, reference is made for the sake of completeness in particular to FIGS. 1 and 2 and the associated description.

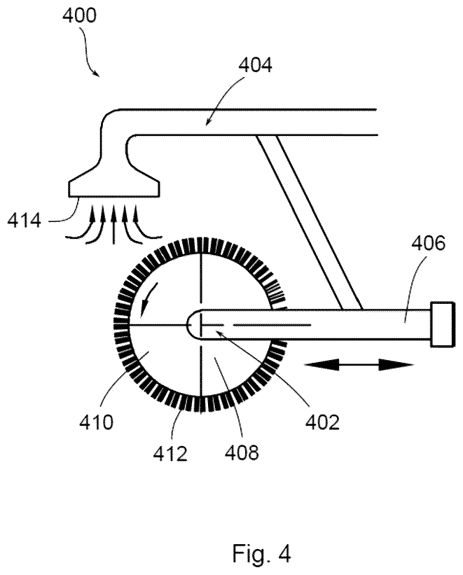

FIG. 4 shows a further variant of a cleaning tool 400. The cleaning tool 400 may be able to be arranged on the cleaning sections described previously, for example.

The cleaning tool 400 comprises a brush unit 402 and an extraction device 404. The brush unit 402 is designed for cleaning the installation component or a part thereof. For this purpose, the brush unit 402 has a carrier element 406 and a brush element 408 mounted in such manner that it can rotate and/or revolve thereon. The brush element 408 is embodied as a rotatable brush and comprises a revolving disc 410, with the bristles 412 of the brush arranged on the periphery of said disc. The brush element 408 or its disc 410 may be caused to rotate by means of a drive (not shown in FIG. 4). The extraction device 404 is also arranged on the carrier element 406, in such manner that a suction opening 414 of the extraction device 404 faces the brush element 408. The extraction device 404 is designed to remove the contaminant by suction.

The cleaning tool 400 is also displaceable (in FIG. 4 from left to right for example). For this purpose, a drive and/or an actuator may be provided. Thus, the cleaning tool 400 may be inserted into the interior of the housing of the cellular wheel sluice 102, for example, or advanced to the cellular wheel 112 of the cellular wheel sluice 102. As a result, the interior of the housing of the cellular wheel sluice 102 or the cellular wheel 112 can be cleaned easily with the rotating brush element 408, and the contaminant arising can be sucked out via the extraction device 404 during the cleaning process.

Otherwise, reference is made for the sake of completeness in particular to FIGS. 1 to 3 and the associated description.

Optional features are qualified in particular with the verb “may”. Accordingly, there are also further developments and/or embodiments that include the respective feature or features as additions or alternatives.

If necessary, isolated features can also be separated out from the feature combinations disclosed here and used in combination with other features to define the scope of the claimed subject matter by resolving a possible structural and/or functional relationship existing between the features.

### REFERENCE NUMERALS

100 Cleaning system
102 Installation component/cellular wheel sluice
104 Conveyor system
106 Bulk material
108 Conveyor line
110 Housing of the cellular wheel sluice
112 Cellular wheel
114 Cleaning apparatus
116 Service station
118 Cleaning tool
120 Extraction device
122 Transport device
124 Carrier section
126 Communication interface
128 Cleaning section
130 Cleaning space
200 Cleaning apparatus
202 Carrier section
204 Cleaning section
206 Cleaning tool/Spraying element
208 Fastening part
210 Movement device/articulated arm
212 Cleaning space
214 Cover piece
216 Lance
218 Spray head
220 Spray nozzle
222 Drive
224 Supply line
300 Cleaning apparatus
302 Carrier section
304 Cleaning section
306 Drive module
308 Fastening part
310 Movement device/Linear guide device
312 Linear guides
314 Cleaning space
316 Housing of the cleaning section
318 Spray nozzles
320 Supply lines
322 Drain line
324 Side cover of the cellular wheel sluice
400 Cleaning tool
402 Brush unit
404 Extraction device
406 Carrier element
408 Brush element
410 Disc
412 Bristles
414 Suction opening

1. A cleaning apparatus for cleaning an installation component of a conveyor system for conveying bulk material, comprising:
at least one cleaning tool for cleaning at least a part of the installation component; and
a carrier section for fastening the cleaning apparatus to the installation component, to a transport device and/or to an external object, wherein the cleaning apparatus is designed to independently initiate a cleaning process for cleaning at least a part of the installation component.

2. The cleaning apparatus according to claim 1, wherein the cleaning apparatus has a communication interface for communicating with the installation component and/or with a controller of the conveyor system, wherein the cleaning apparatus is designed to initiate the cleaning process after a cleaning signal has been received via the communication interface.

3. The cleaning apparatus according to claim 1, wherein the installation component is or comprises a conveyor installation, a feed element, a supply device, a dosing apparatus, a mixing apparatus, a separator, a sluice, a diverter, a gate valve, a butterfly valve or a screw conveyor.

4. The cleaning apparatus according to claim 1, wherein the cleaning apparatus includes a recognition sensor system that is configured to recognise whether the installation component is in an open and/or extended state or whether the installation component is in a closed and/or retracted state.

5. The cleaning apparatus according to claim 1, wherein the cleaning apparatus comprises a cleaning section, which, together with the installation component or a part thereof, is designed to delimit a cleaning space, or is designed to enclose the installation component or a part thereof in a cleaning space.

6. The cleaning apparatus according to claim 1, wherein the carrier section includes a movement device, which is designed to move the cleaning apparatus relative to the installation component.

7. The cleaning apparatus according to claim 1, wherein the cleaning apparatus comprises the transport device, wherein the cleaning apparatus is fastened to the transport device via the carrier section.

8. The cleaning apparatus according to claim 1, wherein the transport device is designed to transport the cleaning apparatus in the form of an autonomously or semi-autonomously self-propelled vehicle or self-flying aerial vehicle.

9. The cleaning apparatus according to claim 1, wherein the transport device is configured for autonomous or semi-autonomous travel operation, for remote control operation, and/or for manual operation.

10. The cleaning apparatus according to claim 1, wherein an environment sensor system is provided, which is configured to provide a controller with the environmental data reproducing an environment of the cleaning apparatus, and/or that a navigation system is provided, which is configured to determine the current position of the cleaning apparatus.

11. The cleaning apparatus according to claim 1, wherein the cleaning apparatus has at least one extraction device for removing dirt by suction.

12. The cleaning apparatus according to claim 1, wherein the cleaning apparatus has at least one storage reservoir for holding an auxiliary material or contaminant, and/or that the cleaning apparatus has at least one transfer interface for transferring an auxiliary material or contaminant.

13. A cleaning system for cleaning an installation component of a conveyor system for conveying bulk material, comprising:
-at least one cleaning apparatus according to claim 1; and
at least one service station for the transfer of at least one auxiliary material and/or contaminant to or from the at least one cleaning apparatus.

14. An assembly comprising at least one cleaning apparatus according to claim 1 and at least one installation component.

15. The assembly according to claim 14, wherein the cleaning apparatus is fastened to the installation component or to the external object by means of the carrier section.

16. The assembly according to claim 14, wherein the at least one installation component is designed to be opened manually or automatically.

17. A conveyor system for conveying bulk material, comprising at least one assembly according to claim 14.
